(19) United States
(12) Patent Application Publication
(10) Pub. No.: US 2003/0223557 A1
(43) Pub. Date: Dec. 4, 2003

(54) Method and apparatus for handset exclusion control

(76) Inventor: Tsahi Tal, Tel Mond (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/156,495

(22) Filed: May 29, 2002

(51) Int. Cl. H04M 11/00

(52) U.S. Cl. 379/93.35; 379/93.05; 379/93.09

(57) ABSTRACT

Briefly, in one example of the present invention, a modem has a modem controller able to generate signals to enable coexistence of a modem session and a voice call. The modem also has a relay to connect and disconnect a handset jack from a data access arrangement (DAA) according to the signals.

### BACKGROUND OF THE INVENTION

Typical modems are connectable both to a telephone line and to a telephone handset, so that when a modem session (data, fax or voice or a combination thereof) is not being handled, the telephone line may be easily accessed through the handset for regular voice telephone calls.

During handling of a modem session, certain activities, such as picking up the handset, dialing and hook on/off of the handset, may cause serious, sometimes irrecoverable, disturbance to the modem session. Therefore, it is common to exclude the handset connection during handling of a modem session. Typically, the handset exclusion is implemented as a logical NOT of the modem hook state. In other words, when there is a modem session in progress, the handset is excluded, and when a modem session is not in progress, the handset is enabled.

The International Telecommunication Union (ITU) V.92 standard enables the coexistence of modem sessions and regular voice telephone calls. For example, a modem session may be put “on hold” in order to accept an incoming regular voice telephone call. In another example, a modem session may be put “on hold” in order to initiate an outgoing regular telephone call.

Accordingly, it will be necessary to implement handset exclusion in a different manner than that described hereinabove.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIGS. 1, 2 and 3 are simplified illustrations of modem cards in accordance with some embodiments of the present invention;

FIG. 4 is a simplified flowchart illustration of a method of activating and deactivating handset exclusion, in accordance with an embodiment of the present invention;

FIG. 5 is an exemplary timing diagram, in accordance with an embodiment of the present invention;

FIG. 6 is a simplified flowchart illustration of a method of activating and deactivating handset exclusion, in accordance with another embodiment of the present invention; and

FIG. 7 is an exemplary timing diagram, in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures and components have not been described in detail so as not to obscure the present invention.

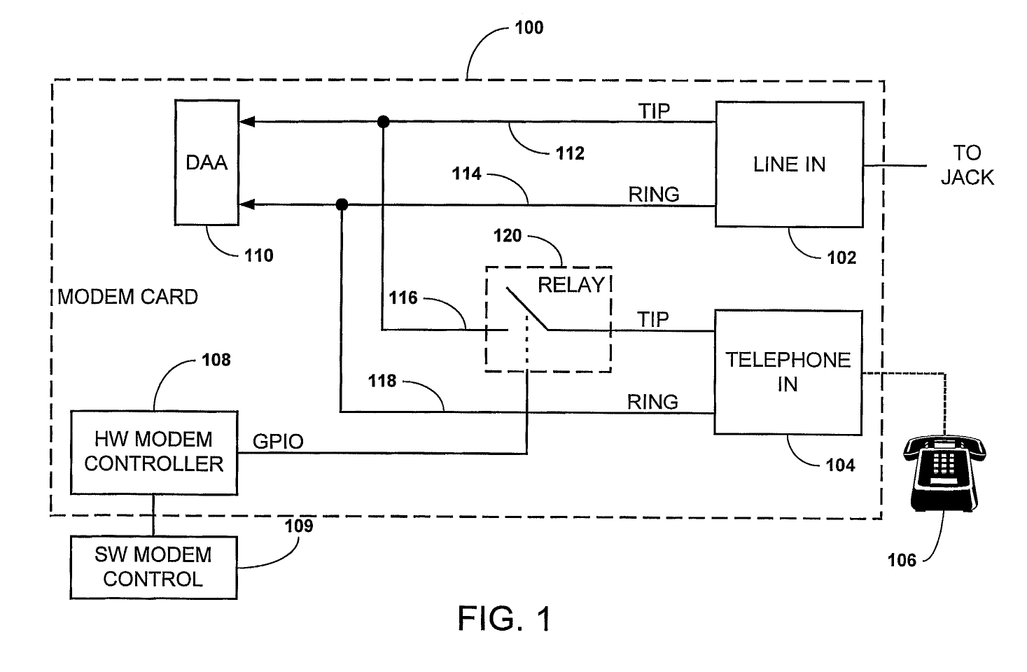

Reference is now made to FIGS. 1, 2 and 3, which are simplified illustrations of modem cards in accordance with some embodiments of the present invention. In FIG. 1, a modem card 100 may comprise a “LINE IN” modem jack 102 and a “TELEPHONE IN” handset jack 104. Handset jack 104 is able to be connected to a telephone 106, while modem jack 102 is able to be connected to a wall outlet of a telephone line (not shown). Modem card 100 may also comprise a hardware modem controller 108 and a data access arrangement (DAA) 110. Modem card 100 may also comprise additional components, but these are not shown in FIG. 1 in order not to obscure the description of embodiments of the present invention. A software modem control 109 is shown in FIGS. 1, 2 and 3, and will be described hereinbelow.

The individual wires of two-wire analog lines connecting telephony devices to the near central office of the telephony network are known as the “Tip” wire and the “Ring” wire. Modem jack 102 may be coupled to DAA 110 via a Tip wire 112 and a Ring wire 114. Similarly, handset jack 104 may be coupled to DAA 110 via a Tip wire 116 and a Ring wire 118.

Hardware modem controller 108 may comprise a general purpose input output (GPIO) pin (not shown). Modem card 100 may comprise a relay 120 controlled by the GPIO signal which may connect or disconnect Tip wire 116.

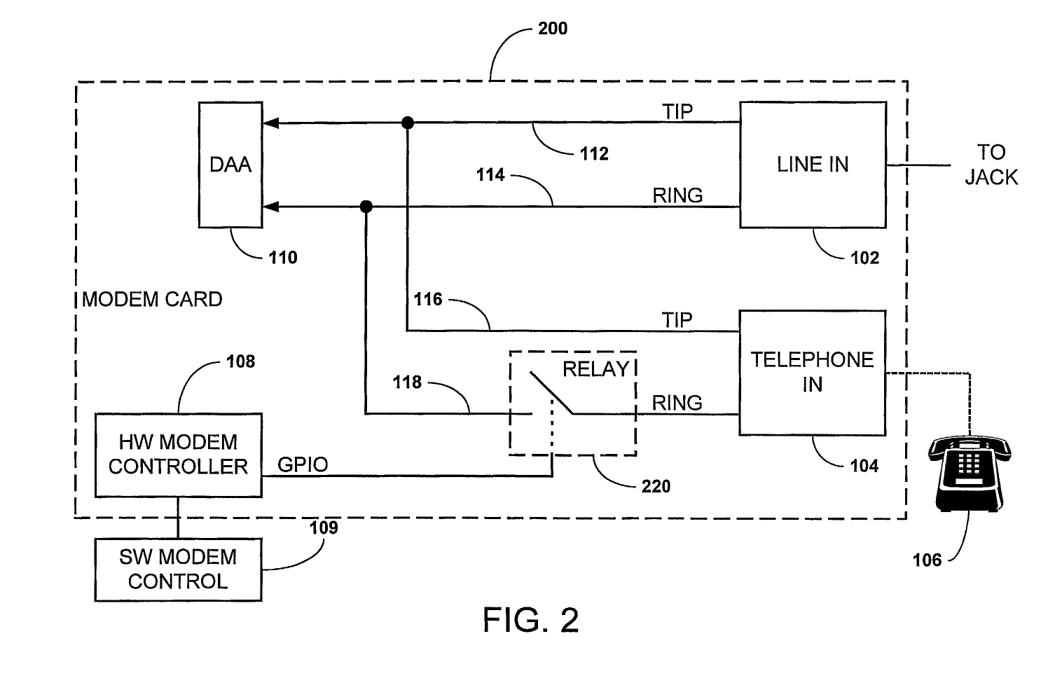

A modem card 200 according to another embodiment of the present invention is shown in FIG. 2. It is similar to modem card 100 of FIG. 1, and reference numerals may be repeated among the figures to indicate corresponding or analogous elements. Modem card 200 may comprise a relay 220 controlled by the GPIO signal which may connect or disconnect Ring wire 118.

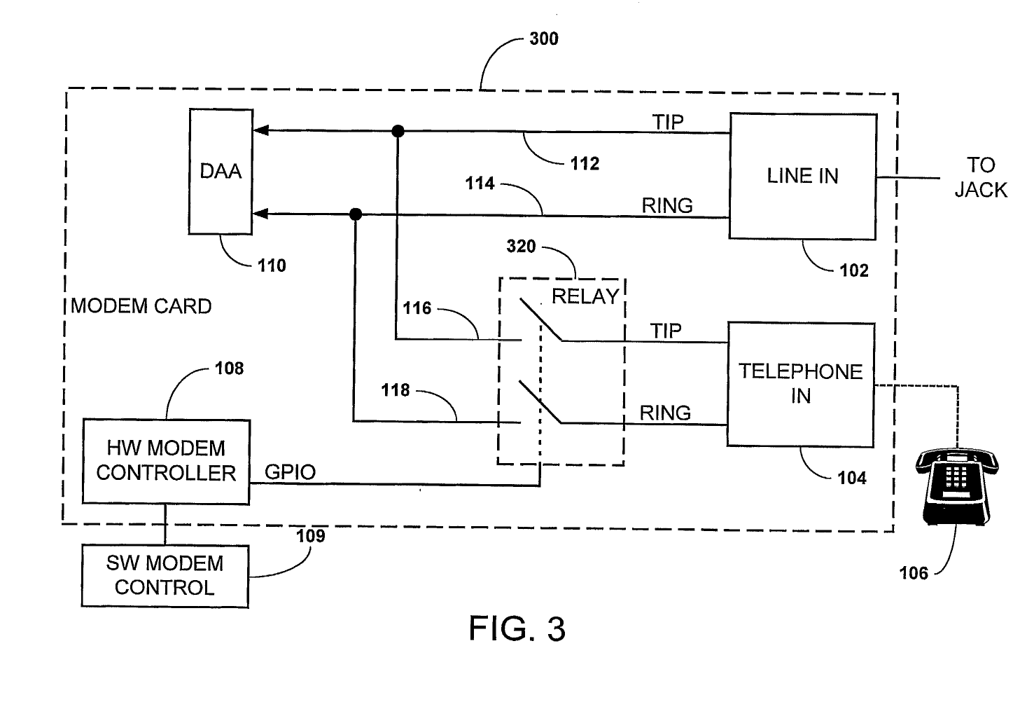

A modem card 300 according to a further embodiment of the present invention is shown in FIG. 3. It is similar to modem card 100 of FIG. 1, and reference numerals may be repeated among the figures to indicate corresponding or analogous elements. Modem card 300 may comprise a relay 320 controlled by the GPIO signal which may simultaneously connect or disconnect Tip wire 116 and Ring wire 118.

Hardware modem controller 108 is a physical unit on the modem card which may provide, among other things, the control pins for the modem card components (such as, for example, the codec clock, control signals for the modem hook, a control signal for handset exclusion, a bridge to the communication port or computer bus). Software modem control 109 is a software module which may contain, among other things, the logic and state machines for control signals of hardware modem controller 108. Additionally, software modem control 109 is responsible for the operation of hardware modem controller 108 throughout the modem session.

Software modem control 109 may be, for example, a software module stored in memory on the host computer (not shown) and running on the central processing unit of the host computer, or may be, for example, software resident on memory (not shown) on modem card 100, running on a microprocessor (not shown) or a digital signal processing chip (not shown) on modem card 100. Control of the handset exclusion is control of the GPIO signal of hardware modem controller 108. Throughout the specification and the claims, the term “modem controller” is used to mean a logical unit comprising a hardware modem controller and a software modem control. The GPIO signal and methods of its control will now be described.

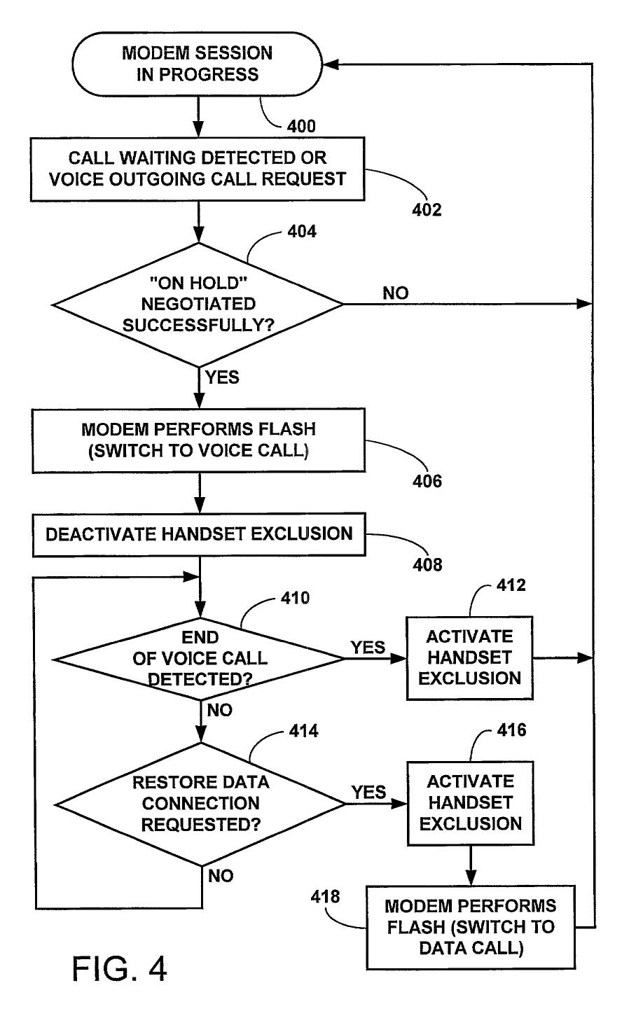

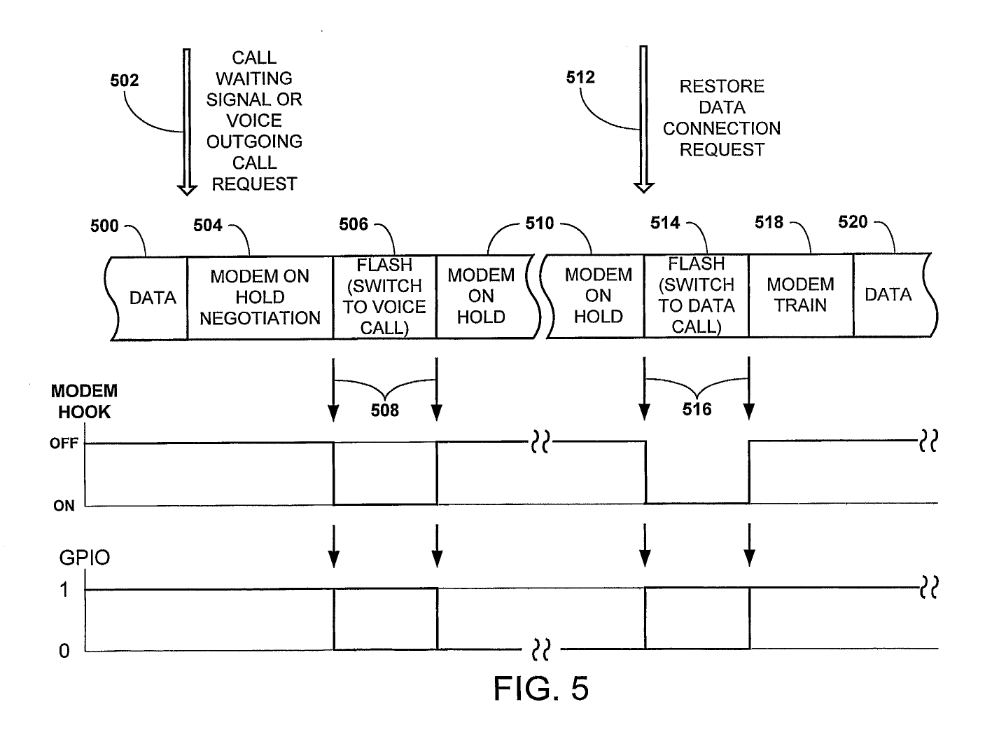

Reference is now made to FIG. 4, which is a simplified flowchart illustration of a method of activating and deactivating handset exclusion, in accordance with an embodiment of the present invention. Reference is made additionally to FIG. 5, which is an exemplary timing diagram for the GPIO signal, in accordance with an embodiment of the present invention. To aid in understanding this embodiment, an exemplary timing diagram for the modem hook is also shown. In the exemplary timing diagram of FIG. 5, a GPIO value of 1 activates handset exclusion (by opening the switch in relay 120, 220 or 320), while a GPIO value of 0 deactivates handset exclusion (by closing the switch in relay 120, 220 or 320). Clearly any two values may be used for the GPIO signal instead of 1 and 0.

A modem session is in progress (block 400) and data 500 is being received and/or transmitted. The modem is “hook off”. The GPIO signal has a value of 1 and handset exclusion is active. The modem may detect a call waiting signal 502 or may receive a request 502 to initiate an outgoing voice call while putting the modem session on hold (block 402). Modem on hold negotiation 504 may be conducted (block 404). If the “on hold” negotiation is not successful, then the modem session may continue as is (block 400). If, however, “on hold” is negotiated successfully, the modem may perform “flash” 506 to switch to the voice call (block 406) and deactivate the handset exclusion (block 408). A “flash” or a “flash switchhook” is a quick “hook on”—“hook off” sequence, such as, for example, a quick hanging up and picking up of the handset, where the period of time of the “hook on” is defined on a country basis according to the communication regulations of that country. During flash, the modem is “hook on”.

The change in the value of the GPIO signal from 1 (handset exclusion active) to 0 (handset exclusion inactive) may occur right after the call waiting signal or voice outgoing call request is received and before “flash” 506 is performed, or during “flash” 506, or after “flash” 506. In other words, it may occur any time between arrows 508. Once “flash” 506 has been completed, the modem is “on hold” 510, and the modem is “hook off”.

Although it is not illustrated in FIG. 5, when the modem is “on hold” 510, the modem may detect the end of the voice call (block 410). The modem may activate the handset exclusion (block 412), may perform a training sequence and may resume the modem session (block 400).

Although the modem does not detect the end of the voice call, perhaps, for example, because the voice call has not yet ended, the modem may receive a request 512 to restore the data connection (block 414). The modem may activate the handset exclusion (block 416) and perform “flash” 514 to switch to the data call (block 418). During flash, the modem is “hook on”.

The change in the value of the GPIO signal from 0 (handset exclusion inactive) to 1 (handset exclusion active) may occur right after the data connection restoration request is received and before “flash” 514 is performed, or during “flash” 514, or after “flash” 514. In other words, it may occur any time between arrows 516. Once “flash” 514 has been completed, the modem session that was previously “on hold” is in progress (block 400). The modem may perform a training sequence 518 and may begin receiving and/or transmitting data 520.

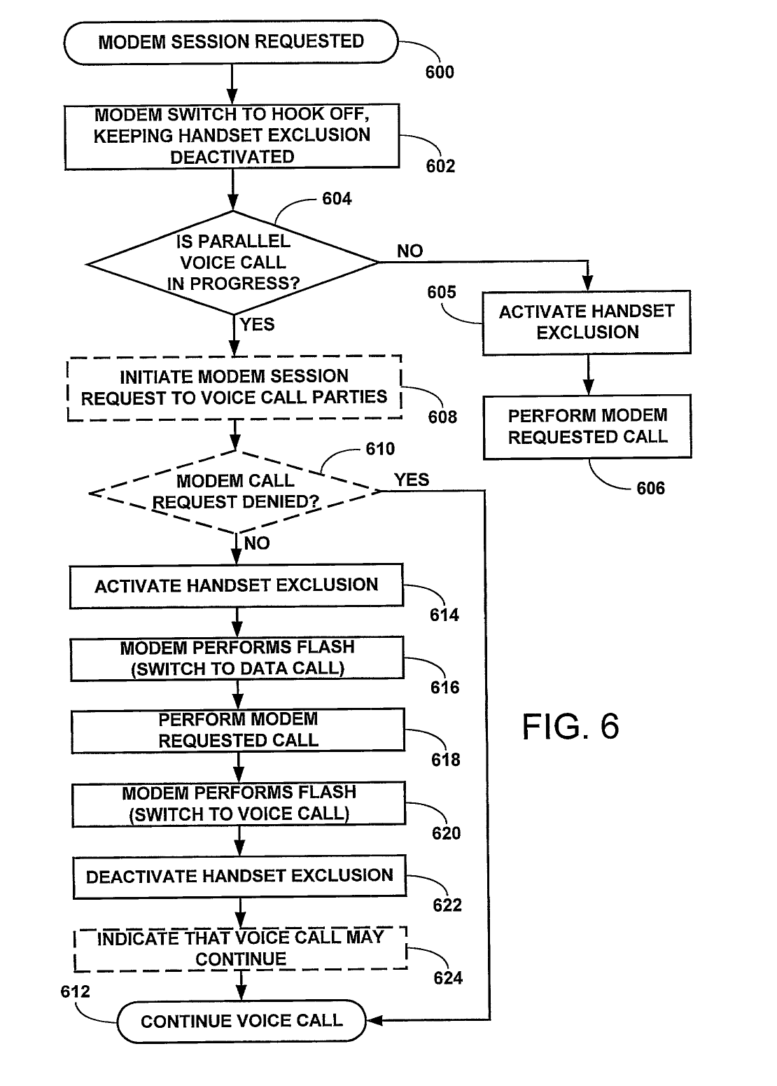

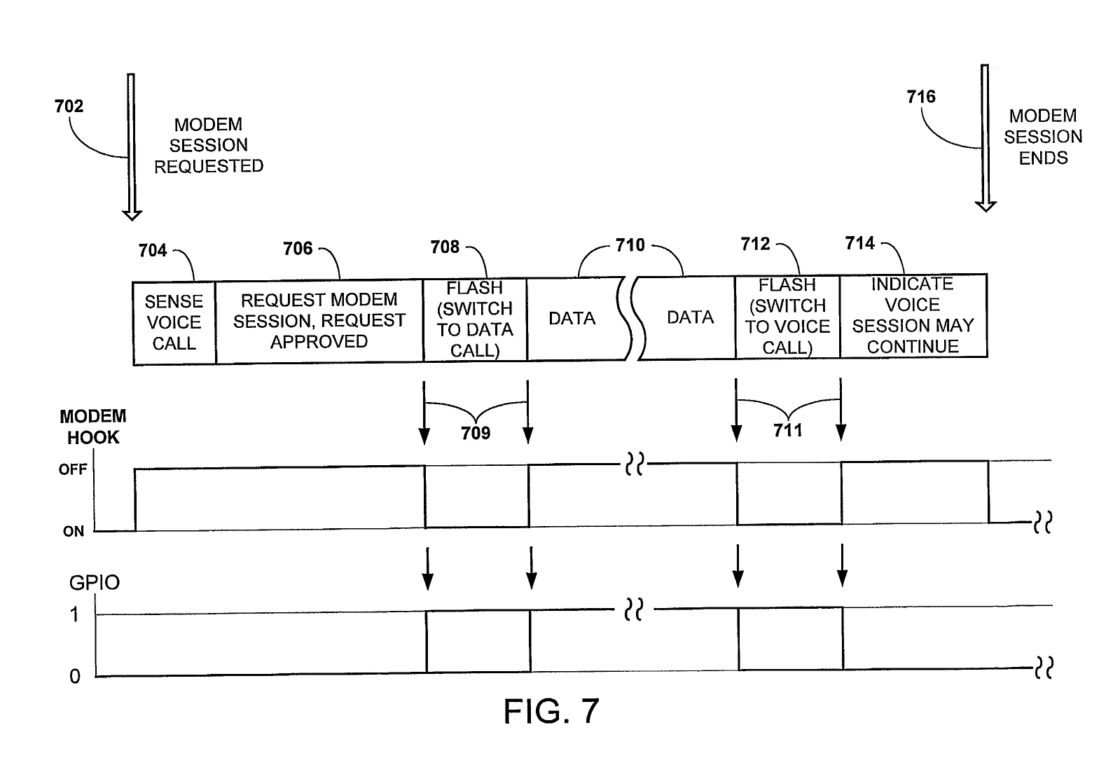

Reference is now made to FIG. 6, which is a simplified flowchart illustration of a method of activating and deactivating handset exclusion, in accordance with another embodiment of the present invention. Reference is made additionally to FIG. 7, which is an exemplary timing diagram for the GPIO signal, in accordance with another embodiment of the present invention. To aid in understanding this embodiment, an exemplary timing diagram for the modern hook is also shown. In tie exemplary timing diagram of FIG. 7, a GPIO value of 1 activates handset exclusion (by opening the switch in relay 120, 220 or 320), while a GPIO value of 0 deactivates handset exclusion (by closing the switch in relay 120, 220 or 320). Clearly any two values may be used for the GPIO signal instead of 1 and 0.

A modem session is requested 702 (block 600), and the modem may switch to “hook off”, while maintaining handset exclusion deactivated (block 602). The GPIO signal has a value of 0 and handset exclusion is inactive. The modem may detect whether a parallel voice call is in progress (block 604). Although it is not illustrated in FIG. 7, if no parallel voice call is in progress, then the modem may activate handset exclusion (block 605) and perform the requested call (block 606).

If, however, the modem senses that a parallel voice call is in progress 704, then a request 706 to the voice call parties to initiate a modem session may optionally be made (block 608). If the request is denied (block 610), then the voice call may continue (block 612).

If the request is approved 706, or alternatively, if no request is made, then the modem may activate the handset exclusion (block 614) and perform “flash” 708 to switch to the data call (block 616). The change in the value of the GPIO signal from 0 (handset exclusion inactive) to 1 (handset exclusion active) may occur before “flash” 708 is performed, or during “flash” 708, or after “flash” 708. In other words, it may occur any time between arrows 709. Once “flash” 708 has been completed, the modem is active and the requested modem session may be initiated, with data 710 being transmitted and/or received (block 618).

Once the modem session is over, the modem may perform “flash” 712 to switch to the voice call (block 620) and deactivate the handset exclusion (block 622). The change in the value of the GPIO signal from 1 handset exclusion active) to 0 (handset exclusion inactive) may occur before “flash” 712 is performed, or during “flash” 712, or after “flash” 712. In other words, it may occur any time between arrows 711. Once “flash” 712 has been completed, an indication 714 to the voice call parties that the voice call may continue may be made (block 624). Then the modem session ends 716, and the voice call may then continue (block 612).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
detecting a call waiting signal on a telephone line when a modem session on said telephone line is in progress and when handset exclusion is active;
placing said modem session on hold;
performing flash to switch to an incoming voice call on said telephone line; and
deactivating said handset exclusion.

2. The method of claim 1, wherein deactivating said handset exclusion occurs before performing said flash.

3. The method of claim 1, wherein deactivating said handset exclusion occurs generally concurrently with performing said flash.

4. The method of claim 1, wherein deactivating said handset exclusion occurs after performing said flash.

5. A method comprising:
receiving a request to initiate an outgoing voice call on a telephone line when a modem session on said telephone line is in progress and when handset exclusion is active;
placing said modem session on hold;
performing flash to enable said outgoing voice call to occur on said telephone line; and
deactivating said handset exclusion.

6. The method of claim 5, wherein deactivating said handset exclusion occurs before performing said flash.

7. The method of claim 5, wherein deactivating said handset exclusion occurs generally concurrently with performing said flash.

8. The method of claim 5, wherein deactivating said handset exclusion occurs after performing said flash.

9. A method comprising:
receiving a request to restore a data connection on a telephone line when a modem session on said telephone line is on hold and handset exclusion is inactive;
activating said handset exclusion; and
performing flash to switch to said data connection.

10. The method of claim 9, wherein activating said handset exclusion occurs before performing said flash.

11. The method of claim 9, wherein activating said handset exclusion occurs generally concurrently with performing said flash.

12. The method of claim 9, wherein activating said handset exclusion occurs after performing said flash.

13. A method comprising:
detecting an end of a voice call on a telephone line when a modem session on said telephone line is on hold and handset exclusion is inactive; and
activating said handset exclusion.

14. A method comprising:
detecting a signal transmitted by a remote modem indicating an end of a voice call on a telephone line when a modem session on said telephone line is on hold and handset exclusion is inactive; and
activating said handset exclusion.

15. A method comprising:
receiving a request to initiate a modem session on a telephone line when handset exclusion is inactive; and
if a parallel voice call is in progress on said telephone line:
activating said handset exclusion; and
performing flash to switch to a data connection.

16. The method of claim 15, wherein activating said handset exclusion occurs before performing said flash.

17. The method of claim 15, wherein activating said handset exclusion occurs generally concurrently with performing said flash.

18. The method of claim 15, wherein activating said handset exclusion occurs after performing said flash.

19. A modem comprising:
a modem controller to produce a first signal to control handset exclusion and a second signal independent of said first signal to control a hook state of said modem.

20. A modem comprising:
a modem controller to produce a signal to control handset exclusion independent of a hook state of said modem.

21. A modem comprising:
a modem controller to generate signals to enable coexistence of a modem session and a voice call; and
a relay to connect and disconnect a handset jack from a data access arrangement (DAA) according to said signal.

22. The modem of claim 21, wherein said relay is able to connect and disconnect a Tip wire from said handset jack to said DAA.

23. The modem of claim 21, wherein said relay is able to connect and disconnect a Ring wire from said handset jack to said DAA.

24. The modem of claim 21, wherein said relay is able to generally simultaneously connect and disconnect a Tip wire from said handset jack to said DAA and a Ring wire from said handset jack to said DAA.
